(19) United States
(12) Patent Application Publication
(10) Pub. No.: US 2008/0068448 A1
(43) Pub. Date: Mar. 20, 2008

(54) Method for adapting a device to participate in video conference calls

(76) Inventor: Robert A. Hansen, Slough (GB)

Correspondence Address: MORRISON & FOERSTER LLP, 755 PAGE MILL RD, PALO ALTO, CA, 94304-1018, US

(21) Appl. No.: 11/522,666

(22) Filed: Sep. 18, 2006

(51) Int. Cl. H04N 7/14

(52) U.S. Cl. 348/14.09

(57) ABSTRACT

The present invention provides a method by which the capabilities of a device that is not specifically adapted for use as a video endpoint can be determined. The capabilities of the device may be, for example, whether or not an application required for the device to act as a video endpoint is present at the device. If the application is not present on the device then the invention provides means by which the device can access the application. The capabilities of the device that are determined may, alternatively, be properties of the device, such as the amount of free memory available to the device's operating system. By determining properties of the device any application being used by the device to connect to a video conference can be altered in order to improve the device's connection to a video call.

### CROSS-REFERENCE TO RELATED APPLICATIONS

Not Applicable

### STATEMENT RE: FEDERALLY SPONSORED RESEARCH/DEVELOPMENT

Not Applicable

### FIELD OF THE INVENTION

This invention relates to a method of enabling a user endpoint to communicate with a second entity on a network. The invention is applicable to the automatic configuration of an endpoint so that it is able to communicate with a multi-conference unit.

### BACKGROUND

In recent years it has become more common for people to use a video call to contact other people. This is because it allows each participant in the video call to view any other participant and gauge the responses and reactions of other participants according to their body language and not just their voice.

The data transmitted by an endpoint associated with each user may be transmitted either directly between endpoints or, more commonly, the data is directed through a Video Multi-conference Unit (MCU) to which the endpoints are connected. When the data from the endpoints is sent to an MCU, the endpoints each receive one or more data streams comprising media data, audio data and control data in the conference call.

A data stream is taken for the purposes of this specification to mean data that is sent from a port in a transmitting device to a port in a receiving device. Additionally it is understood that media data may include video data, image data, a sequence of images, audio data, text data or any desired combination of the above. Similarly, a video call or conference is taken to mean a call or conference which involves the transmission and/or reception of media data. For the purposes of this specification video endpoint is defined as a device used to terminate a video call.

Generally, in order to participate in a video call or conference, a user will use a dedicated endpoint configured to transmit and display images and sounds across a network in an optimal way for displaying media data. For example, it is advantageous to display media data at a high frame rate in order that movements captured in the media data appear smooth. However, if the user does not frequently participate in video conferences then the use of a dedicated video endpoint that is unable to fulfill other functions may not be practical or economical.

The advent of cameras, known as “webcams”, that can be connected to a computer and transmit media data captured by the camera to the computer has enabled computers to be used to transmit media data across a network in real time. For example, media data may be transmitted by the computer across the internet to a second computer.

However, in order to optimally display and transmit media data such as images at an endpoint the endpoint should be configured to enable the optimal image to be obtained and displayed. This is because image data is optimally displayed using a high frame rate in order that movements can be seen more smoothly than file data, such as text data, where movement is not a factor.

Additionally, if the endpoint is also to capture and transmit the user's voice additional adaptations need to be made to the endpoint. The adaptations can be complicated to effect and a user may need knowledge of an endpoint that they do not have, which may prevent a user from using video conferencing. Therefore, it is desirable to provide a way of simplifying access to a video conference.

### BRIEF SUMMARY

According to a first aspect of the present invention there is provided a method of configuring a device so that it can connect to a video conference call hosted by a multi-conference unit (MCU), the method comprising the steps of the MCU transmitting an applet to the device, the applet being adapted to execute on the device and determining whether a video endpoint application is present on the device and causing a video endpoint application to be transmitted to the device if it is not present on the device thereby configuring the device so that it can communicate with the MCU.

Preferably, the method includes the step of the device transmitting an initiation message requesting a connection to the MCU and the MCU transmitting the applet in response to the initiation message.

The applet may be downloaded from one of the group comprising the MCU and an external server.

The video endpoint application may be selected from the group comprising: a codec a user interface and a protocol processor. Preferably, the protocol processor is adapted to encapsulate media data to be transmitted by the device, into a protocol for onward transmission over an electronic communications network. The protocol may be, for example, User Datagram Protocol (UDP), Real-Time Transmission Protocol (RTP), Transmission Control Protocol (TCP) or Hypertext Transfer Protocol (HTTP).

Preferably, the applet determines whether the video endpoint application is the most recent video endpoint application available and, if it is not, causes the device to download the most recent version of the video endpoint application. Alternatively, the applet may determine whether all the video endpoint applications are present on the device and downloading any video endpoint application not present on the device to the device.

Optionally, all the video endpoint applications required to configure the device are downloaded in a bundle.

Preferably, the applet monitors properties of the device and alters the configuration of a video endpoint application in response to a change in the properties of the device. The property may include the free memory of the device, the processing capability of the device, the device's operating system, whether the device supports echo cancellation, the resolution at which media data is captured by the device and the resolution at which the device can display images.

The step of altering the configuration of the device may include changing the codec executing on the device.

According to a second aspect of the present invention there is provided an MCU including a software applet, the applet being arranged for download to and execution on an endpoint; the applet when executed on an endpoint causes the endpoint to determine whether the device includes a video endpoint application configured to enable the device to communicate with a multiconference unit (MCU); and cause a video endpoint application to be transmitted to the device if it is not present on the device thereby configuring the device so that it can communicate with the MCU.

According to a third aspect of the present invention there is provided an applet being executable on a device, and adapted to determine whether the device includes a video endpoint application configured to enable the device to communicate with a multiconference unit (MCU) and cause a video endpoint application to be transmitted to the device if it is not present on the device thereby configuring the device so that it can communicate with the MCU.

### BRIEF DESCRIPTION OF THE DRAWINGS

A specific embodiment of the present invention will now be described by reference to the following drawings in which:

FIG. 1 illustrates a network in which the present invention may be implemented; and

FIG. 2 illustrates a flow diagram showing the configuration of an endpoint.

### DETAILED DESCRIPTION

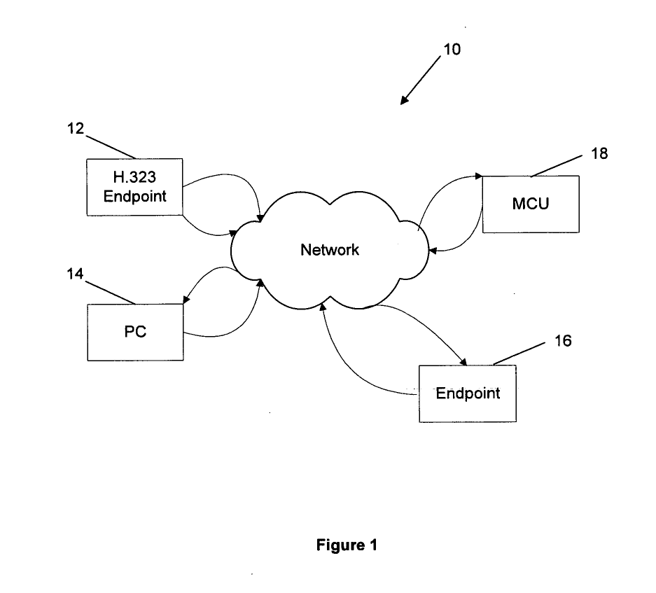

FIG. 1 illustrates a network 10 in which the present invention may be implemented. The network illustrated in FIG. 1 is a wide area network (WAN); however the present invention may also be implemented when an endpoint is located within a local area network (LAN). The invention may also be implemented on any other suitable network configuration.

Endpoints 12, 14, 16 are connected via the network 10. The endpoints 12, 14, 16 may be H.323 endpoints 12, SIP endpoints (not shown) or any other suitable type of endpoint 16. The endpoints may or may not have H.239 capability. Alternatively, an endpoint may be a personal computer 14 or any other device that is capable of being configured to act as a video endpoint.

A Multi-Conference Unit (MCU) 18 is also present in the network. The network, as discussed above, acts to receive data transmitted by any endpoints 12, 14, 16 participating in a video conference, and to transmit combined media data to the endpoints 12, 14, 16.

In order for a device 14, 16 to serve as a video endpoint it must be configured to encode video, audio and any other media data that is to be sent to an MCU 18 into a suitable format for transmission. The MCU 18 is also preferably able to decode and process the format in which the data is transmitted. Additionally, the device 14, 16 is preferably able to decode media data transmitted by the MCU 18. Furthermore, the device 14, 16 must be able to decode and execute control data, such as an invitation message requesting a connection between the MCU 18 and the computer, transmitted by the MCU 18.

A user wishing to connect to a video conference using a device 14, 16 such as their personal computer may use the present invention to automatically configure the computer such that it can communicate with the MCU and act as a video endpoint.

A device in the present invention is connected to a network and is provided with means for locating an MCU. For example the MCU may be able to be accessed through a web interface such as a web page that can be found using a web browser such as Microsoft Internet Explorer, Firefox or Netscape. The user may, once they have accessed the webpage, be presented with a list of available conferences hosted by one or more MCU. When the user selects a desired available conference the device sends an initiation message, described in more detail below, to the MCU hosting the conference, requesting connection to the MCU and the conference.

Alternatively the user may have been provided with a network address that they can use to directly contact an MCU. The user may then input the address into the user interface to cause the device to send a request message to the MCU requesting a connection to a conference or the MCU. In response to the request message the MCU will send a list of conferences that are being hosted by it. Once the user at the device has selected the desired conference the device sends an initiation message, described in more detail below, to the MCU hosting the conference, requesting connection to the MCU and the conference.

The MCU may require the device to transmit information about a user to the MCU before the device can connect to a conference that is being hosted by the MCU. If the MCU is configured to require registration then, on receipt of an initiation message from an device that is not registered with the MCU, the MCU may request user information from the device's user such as the user's name, a password and any preferred settings.

Preferably, the user is able to edit any user information stored on the MCU by accessing a menu provided at the device, for example by a video endpoint application, as discussed below. Alternatively, the user may use a web interface to interact with the MCU. In this instance, when the MCU receives an initiation message from a device that is not registered with the MCU then the MCU causes a form to be displayed using a browser provided at the device in which the user can enter user information. On receipt of the user's details the MCU preferably stores the details in a database or other storage means.

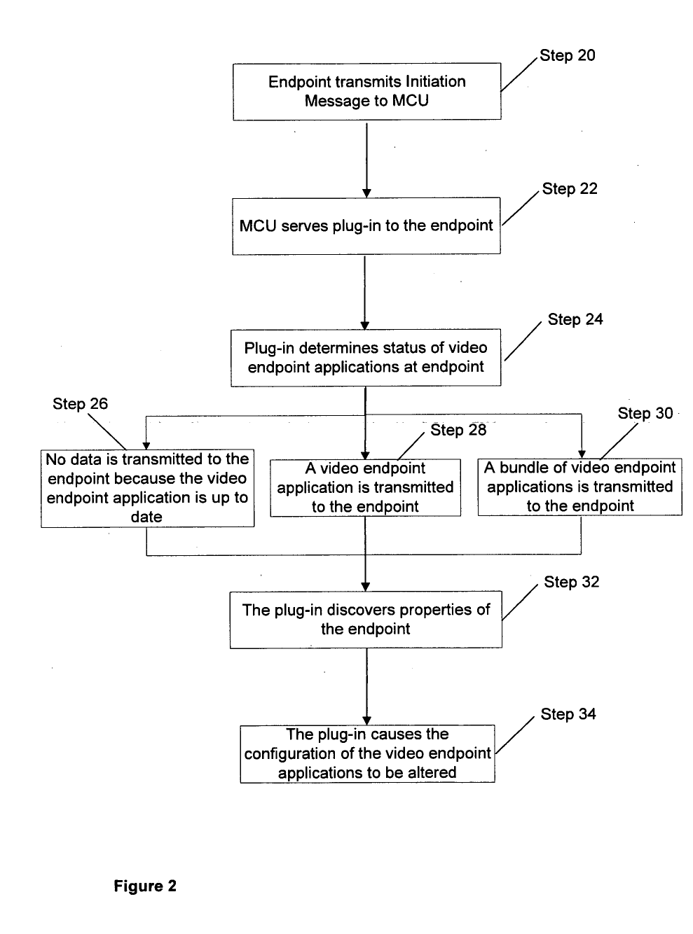

The MCU, on receiving an initiation message as illustrated in Step 20 of FIG. 2, determines the method that the computer is using to access the MCU, for example it may identify the browser or operating system being used by the device. The MCU can then serve a plug-in (Step 22) or any other suitable applet to the device. The applet is a computer application that is able to determine whether a video endpoint application is present on the computer. A video endpoint application is an endpoint program or other device which enables a device on which it is present to fulfill all or at least part of the functions provided by a video endpoint. For example, the video endpoint application may be a specific codec or user interface required for the device to act as a video endpoint in a video conference call.

The plug-in then detects the status of any video endpoint application on the device (Step 24).

If the plug-in detects that one or more video endpoint applications have not been installed on the device then the plug-in will detect the set-up of the device onto which the application is to be loaded, for example operating system properties such as whether the operating system can support echo cancellation thereby allowing audio data to be transmitted in full duplex mode. Additional properties for which information may be sourced by the plug-in include system information such as the resources of the device, for example the amount of free memory available at the device, or the device's processing capability.

The MCU will then transmit and install the video endpoint applications on the device. If a video endpoint application is present on the device but there is a more recent version of the video endpoint application present at the MCU then the version of the application present on the device may be updated (not shown). If the video endpoint application present on the device is the most up to date version then no video endpoint application is transmitted to the device (Step 26).

The plug-in may be configured to identify a particular video endpoint application that is absent or needs to be updated and downloaded to that particular application (Step 28). Alternatively, the video endpoint applications may only be downloaded to the device as a bundle of all the video endpoint applications that are required to configure a device so that it can act as a video endpoint (Step 30). If this is the case then the bundle is downloaded if the plug-in determines that one or more of the video endpoint applications, all the video endpoint applications, or alternatively the bundle, are not present on the device or are not the most recent versions.

It may be desirable to provide the application or bundle with mechanisms to ensure that the correct program is downloaded without any alterations, additions or deletions being made by a third party, for example for the insertion of a computer virus. This may be achieved, for example, by providing the application or bundle with a digital signature enabling the device to verify that the transmitted application or bundle is authentic and originated from the MCU.

The video endpoint application may be downloaded automatically without the user providing any information on the computer's capability. The plug-in may then determine one or more properties of the device (Step 32) and configure the video endpoint application present on the device (Step 34) without any user input. This simplifies the modification of the device for the user. Alternatively, the user may choose to manually download the video endpoint applications. The user may also choose to manually input the desired configuration of the video endpoint applications.

A video endpoint application to be downloaded to a device may be sourced from and transmitted by the MCU. Alternatively the video endpoint applications may be stored on a separate server. If the video endpoint applications are stored on a separate server the MCU, on receiving a message from the device, transmits a further message to the server requesting that the video endpoint application or bundle is transmitted to the MCU which then forwards the application or bundle to the device. Alternatively the server may transmit the video endpoint application or bundle directly to the device.

As described above the plug-in detects the properties of the device's operating system and can, therefore, configure how the video endpoint application is implemented on the device. For example, the plug-in may select a suitable codec to be implemented taking into account. The device's processing power. The user may be notified before any adjustments are made to any application present on the device or, alternatively, the adjustments may be made automatically with no user input.

Preferably, the video endpoint application also enables the device to encapsulate data being transmitted to the MCU using a media protocol such as H.323 or SIP in a message with a header from a second protocol.

It is desirable to transmit data from the device in this manner because the media data is advantageously transmitted using a media protocol. However, it is common for a firewall to intercept data sent using a media protocol and therefore it is advantageous to encapsulate this data in a streaming protocol using a protocol processor.

The protocol processor is a device that is adapted to encapsulate data in a protocol ready for onward transmission over an electronic communication network typically which is transmitted from a port in the transmitting device to a port in the receiving device. The protocol may be, for example, transmission control protocol (TCP), user datagram protocol (UDP), real-time transmission protocol (RTP), hypertext transfer protocol (HTTP) or any other suitable protocol.

Prior to transmitting media data to the MCU it is preferable that the preferred protocol in which the data should be encapsulated is selected. The preferred protocol is selected by transmitting a test message to the MCU, using a selected protocol, and determining whether the test message is received by the MCU. This may be, for example, by determining whether an acknowledgement message is received by the computer within a predetermined amount of time. If the message is received by the MCU then that protocol is used to transmit all subsequent data to the MCU using that protocol. If the message is not received by the MCU then a further test message may be sent using an alternative protocol or the connection may be denied.

For example, the preferred protocol may be UDP because it requires less processing and is therefore faster than TCP or HTTP. The computer therefore sends a first test message to the MCU using UDP and, if the message is determined to have reached the MCU, all further data transmitted to the MCU is transmitted encapsulated in UDP. If, however, the first test message does not reach the MCU then a second test message is transmitted using a second protocol, for example TCP which, although it requires more processing than UDP, is more reliable than UDP. If the second test message is received by the MCU then data is transmitted to the MCU using TCP. If the test message is not received by the MCU then a third test message may be transmitted to the MCU using a third protocol, for example HTTP. HTTP is preferably used as the third protocol as although it is more reliable than UDP and TCP, it requires a larger overhead. If the third test message encapsulated using HTTP is received by the MCU then all further data is transmitted to the MCU encapsulated using HTTP. If the third test message is not received by the MCU then further test data could be transmitted to the MCU using alternative protocols or the connection to the MCU could be denied.

The plug-in may also cause data to be encoded using base 64 before it is encapsulated in an HTTP message and transmitted to the MCU. This may reduce the bandwidth required to transmit the data to the MCU when it is encapsulated using HTTP.

Preferably, the plug-in is able to monitor the properties of the device on which it has been downloaded, for example the device may monitor the amount of free memory available, the computer's processor speed, operating system or the resolution at which the webcam that captures images of the user works at. On detecting a change in a property of the device the plug-in may then adjust a property of the video endpoint application or bundle that is controlling the video-endpoint configured device.

The plug-in may adjust a codec, for example by changing the codec from ITU-T H.263, which achieves relatively low data compression resulting in a higher bandwidth requirement and a relatively low amount of processing, to ITU-T H.264 which achieves a relatively high amount of data compression resulting in less bandwidth being required but a greater amount of processing power from the operating system. Altering the codec which is being used to encode/decode the audio and media data means that the best quality audio and media data is transmitted, taking into account the free memory, processor speed or any other suitable characteristics of the device's set up.

A video endpoint application may also be configured to monitor the bandwidth of the connection between the MCU and the device. The application can then use this information to determine how much data is transmitted to the MCU. For example, if the bandwidth decreases then the application may select to send less data to the MCU. This may be achieved by reducing the resolution of media data, reducing the frame rate or any other suitable alteration. 10051] The user at the device is preferably provided with a user interface including a variety of inputs which can be used to alter, for example, the display of media data at the device. For example, the user could choose to display all participants in a video conference in equal sized panes. Alternatively, the user may select to view a single participant in a large pane with the remaining participants in smaller panes. This may be achieved by providing an input on the display of the device which the user can select to alter the display of media data on the device display or any other suitable means. Inputs could also be provided to allow the user to select that the participant viewed in the large pane is the participant who is speaking, so called voice switching.

The display formats which the user is able to access may, however, be limited by the MCU according to the properties of the device as discussed above. Alternatively, the display format may only be controlled by a single person, for example the user who set up the conference, so that the same layout is displayed at all devices connected to the video conference. For example, it may be desired that the most senior person participating in the video conference is always displayed in the top left corner of a display device connected to or forming part of a device. If the user controlling the display format is at a device configured in the manner described above then the display may be controlled using the user interface.

Preferably the user-interface enables the user to alter features of the device, and even change video conferences without having to use far end camera controls such as those described in the co-pending U.S. patent application Ser. No. 10/962,912, the disclosure of which is herein incorporated by reference. Even more preferably the user-interface enables a user to configure the device features without having to exit a conference they are participating in.

What is claimed is:

1. A method of configuring a device so that it can connect to a video conference call hosted by a multi-conference unit (MCU), the method comprising the steps of:
a) the MCU transmitting an applet to the device;
b) the applet being adapted to execute on the device and determining whether a video endpoint application is present on the device; and
c) causing a video endpoint application to be transmitted to the device if it is not present on the device thereby configuring the device so that it can communicate with the MCU.

2. A method of configuring a device according to claim 1 further comprising the step of the device transmitting an initiation message requesting a connection to the MCU and the MCU transmitting the applet in response to the initiation message.

3. A method of configuring a device according to claim 1 wherein the applet is downloaded from one of the group comprising the MCU and an external server.

4. A method of configuring a device according to claim 1 wherein the video endpoint application includes one of the group comprising: a codec a user interface and a protocol processor.

5. A method of configuring a device according to claim 4 wherein the protocol processor is adapted to encapsulate media data to be transmitted by the device into a streaming protocol.

6. A method of configuring a device according to claim 5 wherein the streaming protocol includes one of the group comprising User Datagram Protocol (UDP), real-time transmission protocol (RTP), Transmission Control Protocol (TCP) or Hypertext Transfer Protocol (HTTP).

7. A method of configuring a device according to claim 1 wherein the applet determines whether the video endpoint application is the most recent video endpoint application available and, if it is not, causes the device to download the most recent version of the video endpoint application.

8. A method of configuring a device according to claim 1 further comprising the applet determining whether all the video endpoint applications are present on the device and downloading any video endpoint application not present on the device to the device.

9. A method of configuring a device according to claim 1 wherein the all the video endpoint applications required to configure the device are downloaded in a bundle.

10. A method of configuring a device according to claim 1 wherein the applet monitors properties of the device and alters the configuration of a video endpoint application in response to a change in the properties of the device.

11. A method of configuring a device according to claim 10 wherein a property of the device is selected from the group comprising: the free memory of the device, the processing power of the device, the device's operating system, whether the device supports echo cancellation, the resolution at which media data is captured by the device and the resolution at which the device can display images.

12. A method of configuring a device according to claim 10 wherein the step of altering the configuration of the device comprises changing the codec executing on the device.

13. An MCU including a software applet, the applet being arranged for download to and execution on a device; the applet when executed on the device being arranged to cause the device to determine whether the device includes a video endpoint application configured to enable the device to communicate with a multiconference unit (MCU); and to cause a video endpoint application to be transmitted to the device from the MCU if it is not present on the device thereby configuring the device so that it can communicate with the MCU.

14. An applet being executable on a device, and adapted to:
a) determine whether the device includes a video endpoint application configured to enable the device to communicate with a multiconference unit (MCU); and
b) cause a video endpoint application to be transmitted to the device if it is not present on the device thereby configuring the device so that it can communicate with the MCU.
